(19) United States
(12) Patent Application Publication
(10) Pub. No.: US 2026/0152243 A1
(43) Pub. Date: Jun. 4, 2026

(54) CRAWLER VEHICLE AND CONTROL METHOD TO CONTROL SAID CRAWLER VEHICLE

(71) Applicant: PRINOTH S.P.A., Vipiteno (IT)

(72) Inventors: Francesco Salis, Vipiteno (IT); Martin Kirchmair, Vipiteno (IT); Alberto Paoletti, Vipiteno (IT)

(21) Appl. No.: 19/404,686

(22) Filed: Dec. 1, 2025

(30) Foreign Application Priority Data
Dec. 2, 2024 (IT) 102024000027249

(51) Int. Cl. B62D 55/112; B62D 55/10; B62D 55/12; B62D 55/14

(52) U.S. Cl. CPC B62D 55/112; B62D 55/10; B62D 55/12; B62D 55/14

(57) ABSTRACT

A crawler vehicle having a frame; two wheel assemblies arranged on opposite sides of the frame, wherein each wheel assembly comprises a drive wheel and a plurality of idle wheels; and two tracks, each of which is arranged around the respective wheel assembly. The crawler vehicle has a suspension comprising at least two semi-active hydraulic dampers, each of which has a respective variable damping coefficient, is associated with one of the wheel assemblies, and comprises a hydraulic cylinder connecting to the frame at least one of the idle wheels of the respective wheel assembly. The crawler vehicle has a control device configured to control each hydraulic damper so as to adjust the respective damping coefficient.

### PRIORITY CLAIM

This application claims the benefit of and priority to Italian Patent Application No. 102024000027249, filed on Dec. 2, 2024, the entire contents of which is incorporated by reference herein.

### TECHNICAL FIELD

The present disclosure relates to a crawler vehicle, such as a crawler vehicle used for preparing ski runs, and a control method for controlling the crawler vehicle.

### BACKGROUND

Crawler-type vehicles are commonly used to advance along off-road routes in order to transport goods and/or people and/or to carry out a wide range of different jobs, such as preparing the snow cover of ski runs or cleaning beaches, or for agricultural operations.

Generally, a crawler vehicle comprises a frame; a propulsion system mounted on the frame; two locomotion units, each of which is provided with a respective drive wheel driven by the propulsion system, a plurality of idle wheels, and a respective track arranged around the drive wheel and idle wheels; and a suspension, which connects the idle wheels to the frame.

As the crawler vehicle advances along an off-road route, such as on terrain or snow cover, the suspension dampens vibrations transmitted to the frame by the idle wheels and tracks in contact with the terrain or snow cover, improving the relative comfort of the driver and/or passengers on board the crawler vehicle and positively influencing the dynamics of the crawler vehicle.

However, since the structure of the terrain or snow cover on which the crawler vehicle advances is unpredictable and varies over time depending on the weather conditions, the frequency and amplitude of vibrations transmitted by the idle wheels to the frame are relatively difficult to predict. Moreover, the vibrations vary depending on the travelling speed of the crawler vehicle.

As a result, currently known suspensions are not able to optimally dampen the vibrations transmitted by the idle wheels and tracks to the frame under the various operating conditions of the crawler vehicle.

### SUMMARY

An aim of the present disclosure is to realize a crawler vehicle that mitigates certain of the drawbacks of certain of the prior art.

In accordance with certain embodiments of the present disclosure, a crawler vehicle is realized, such as a crawler vehicle for preparing ski runs. In these embodiments, the crawler vehicle is configured to advance in a travelling direction and comprises a frame; and two wheel assemblies arranged on opposite sides of the frame, wherein each wheel assembly comprises a drive wheel and a plurality of idle wheels. The crawler vehicle of these embodiments further comprises two tracks, each of which is arranged around the respective wheel assembly; and a suspension comprising at least two semi-active hydraulic dampers, each of which has a respective variable damping coefficient, is associated with one of the wheel assemblies, and comprises a hydraulic cylinder connecting at least one of the idle wheels of the respective wheel assembly to the frame. The crawler vehicle of these embodiments also comprises a control device configured to control each hydraulic damper in order to adjust the respective damping coefficient.

In accordance with certain embodiments of the present disclosure, it is possible to adapt the damping coefficient of each hydraulic damper to the specific operating conditions of the crawler vehicle, in particular to the characteristics of the terrain or snow cover on which the crawler vehicle advances, or to the travelling speed of the crawler vehicle. In this way, vibrations transmitted from the wheel assemblies to the frame of the crawler vehicle can be optimally dampened to improve the dynamics of the crawler vehicle and the relative comfort of the driver and/or passengers of the crawler vehicle.

A further aim of the present disclosure is to provide a control method for controlling a crawler vehicle that mitigates certain of the drawbacks of certain of the prior art.

In accordance with certain embodiments of the present disclosure, a control method is provided to control a crawler vehicle as described above. In these embodiments, the control method comprises detecting an acceleration signal indicative of the acceleration of the frame in a direction substantially perpendicular to the travelling direction of the crawler vehicle; detecting a stroke signal indicative of a length of one of the hydraulic cylinders; and adjusting the damping coefficient of the hydraulic damper comprising the hydraulic cylinder as a function of the detected acceleration signal and the detected stroke signal. In accordance with the method of these embodiments, it is possible to control each hydraulic damper in real time and automatically in order to optimize the damping of vibrations transmitted by the wheel assemblies to the frame of the crawler vehicle under all operating conditions.

### BRIEF DESCRIPTION OF THE DRAWINGS

Further features and advantages of the present disclosure will become clear from the following description of a non-limiting embodiment thereof, with reference to the accompanying Figures, wherein:

FIG. 1 is a plan view, with parts removed for clarity and parts schematised, of a crawler vehicle made In accordance with certain embodiments of the present disclosure;

FIG. 2 is an enlarged plan view, with parts removed for clarity and parts schematised, of a detail of the crawler vehicle in FIG. 1;

FIG. 3 is a schematised view, with parts removed for clarity, of a further detail of the crawler vehicle in FIG. 1; and

FIG. 4 is a flow chart of a control method of the crawler vehicle of FIG. 1.

### DETAILED DESCRIPTION

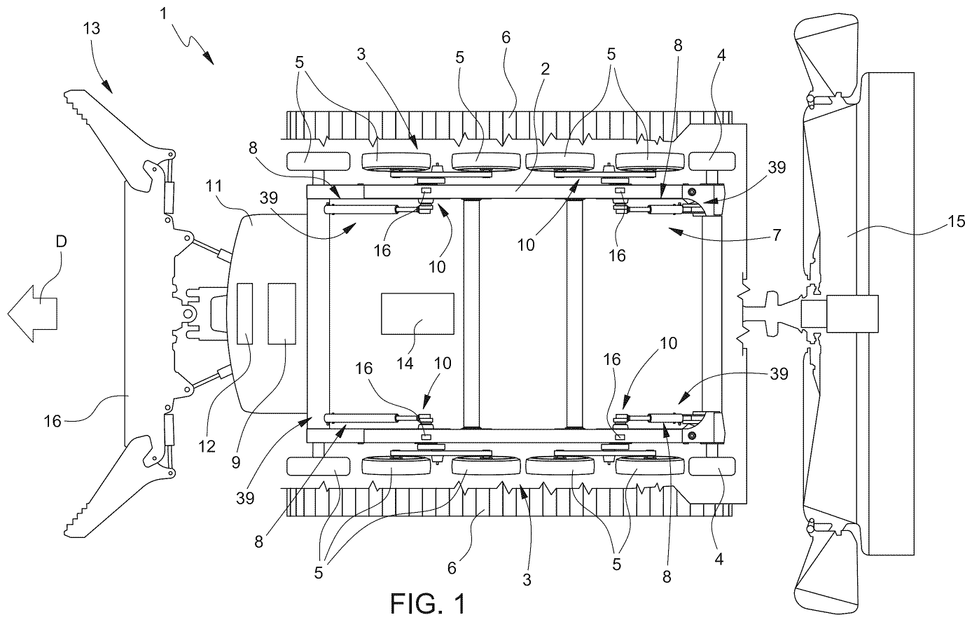

With reference to FIG. 1, number 1 denotes a crawler vehicle, which in the case illustrated is used to prepare ski runs. In certain embodiments, the crawler vehicle 1 is a snow groomer. In more detail, the crawler vehicle 1 is used for preparing one or more of alpine ski runs, cross-country ski runs, ski-jumping ramps, “half-pipe” ski runs, and/or “snow-parks”.

In accordance with certain further embodiments, the crawler vehicle 1 can be used for the maintenance of sandy expanses, such as beaches, or for operations in agriculture, such as one or more of harvesting of agricultural products, handling of agricultural products, forage silage, harvesting bagasse and/or handling of bagasse.

In addition, in accordance with certain further embodiments (not shown in the Figures), the crawler vehicle 1 comprises a mulcher, such as a mulcher positioned at the front of crawler vehicle 1, and can be used for shredding vegetation.

In accordance with certain embodiments of the present disclosure, the crawler vehicle 1 is configured to advance in a travelling direction D and comprises a frame 2; two wheel assemblies 3 arranged on opposite sides of the frame 2 (wherein each wheel assembly 3 comprises a drive wheel 4 and a plurality of idle wheels 5); and two tracks 6 (each of which is arranged around the respective wheel assembly 3) The crawler vehicle also comprises a suspension 7 comprising at least one semi-active hydraulic damper 39, which has a variable damping coefficient, is associated with one of the wheel assemblies 3, and comprises a hydraulic cylinder 8 connecting to the frame 2 at least one of the idle wheels 5 of the respective wheel assembly 3. The crawler vehicle further comprises a control device 9 configured to control each hydraulic damper 39 so as to adjust the respective damping coefficient.

In certain non-limiting embodiments of the present disclosure, the suspension 7 comprises four hydraulic cylinders 8, each of which connects two respective idle wheels 5 to the frame 2. In certain embodiments, two hydraulic cylinders 8 are associated with one of the wheel assemblies 3 and two further hydraulic cylinders 8 are associated with the other of the wheel assemblies 3.

In certain embodiments, the suspension 7 comprises, for each hydraulic cylinder 8, a connecting assembly 10, which connects the respective hydraulic cylinder 8 to two idle wheels 5 of the respective wheel assembly 3.

In certain embodiments, the idle wheels 5 of each wheel assembly 3 are aligned with each other along a direction substantially parallel to the travelling direction D and, in this case, each wheel assembly 3 comprises five idle wheels 5.

In certain embodiments, the crawler vehicle 1 comprises a driver's cab 11 mounted on the frame 2; a user interface 12, which is arranged in the driver's cab 11 and is configured to enable control of the crawler vehicle 1 by a driver; a set of accessory devices 13 connected to the frame 2; and a propulsion system 14 (e.g., internal combustion or electric or hydrogen-powered) configured to transmit power to the drive wheels 4 and to power supply the set of accessory devices 13.

In certain non-limiting embodiments of the present disclosure, the set of accessory devices 13 comprises a tiller 15, a shovel 16, and a winch (not shown in the Figures). It is understood that the crawler vehicle 1 does not necessarily comprise all of the accessory devices 13 mentioned above. For example, the crawler vehicle 1 may comprise any one or two of the accessory devices 13 selected from tiller 15, shovel 16 and winch.

In certain embodiments, the crawler vehicle 1 comprises an acceleration sensor 17, which is in communication with the control device 9 and is configured to detect an acceleration signal indicative of the acceleration of the frame 2 in a direction substantially perpendicular to the travelling direction D. In greater detail, the acceleration sensor 17 is configured to detect the acceleration signal in a substantially vertical direction. As an example, the acceleration sensor 16 is an accelerometer.

In certain non-limiting embodiments of the present disclosure, the crawler vehicle 1 comprises four acceleration sensors 17, each of which is fixed near a respective corner portion of the frame 2, at the respective connecting assembly 10.

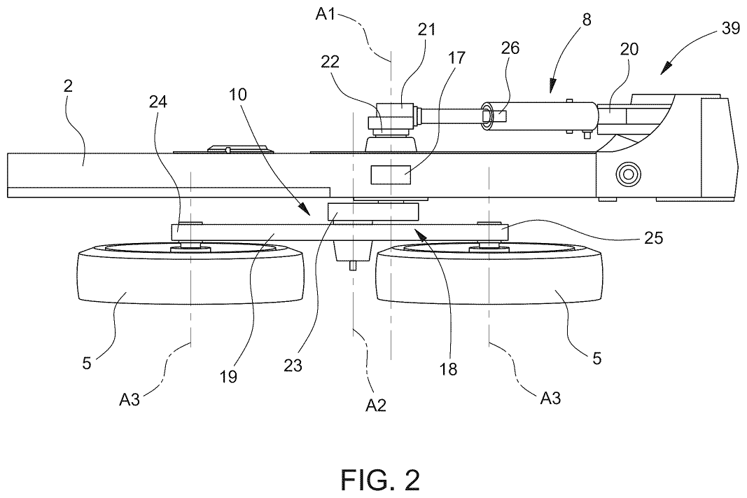

With reference to FIG. 2, each connecting assembly 10 comprises a swivel arm 18, which is connected to the respective hydraulic cylinder 8 and is hinged to the frame 2; and a support crossbar 19, which is hinged to the swivel arm 18 and rotatably supports the two respective idle wheels 5.

In certain embodiments, each hydraulic cylinder 8 has a respective end 20 hinged to the frame 2 and a respective end 21 hinged to the respective swivel arm 18. In more detail, each swivel arm 18 comprises an elongated body 22, which is hinged to the frame 2 around a rotation axis A1 and, in particular, extends through a through opening (not visible in the Figures) formed in the frame 2; and a crank 23, which is integral with the elongated body 22 and extends in a direction substantially perpendicular to the rotation axis A1.

In certain embodiments, each support crossbar 19 extends in a direction substantially perpendicular to the rotation axis A1 and is hinged at one end of the respective crank 23 about a rotation axis A2 substantially parallel to the rotation axis A1. In more detail, each support crossbar 19 has a respective end 24 to which one of the idle wheels 5 is hinged and a respective end 25 to which another of the idle wheels 5 is hinged. In certain non-limiting embodiments, each idle wheel 5 is hinged to the support crossbar 19 about a respective rotation axis A3 substantially perpendicular to the rotation axis A2.

In certain embodiments, the crawler vehicle 1 comprises, for each hydraulic cylinder 8, a stroke sensor 26, which is in communication with the control device 9 and is configured to detect a stroke signal indicative of the length of the respective hydraulic cylinder 8.

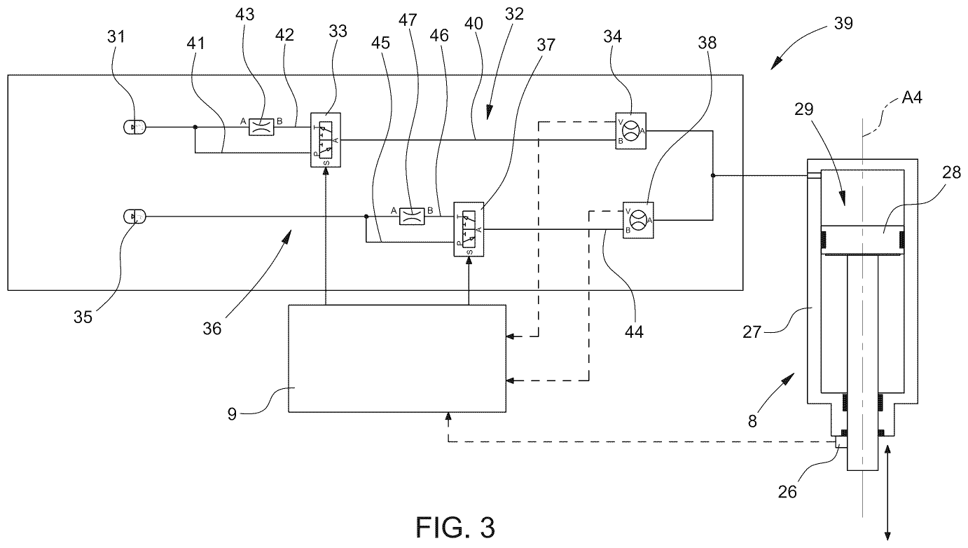

With reference to FIG. 3, each hydraulic cylinder 8 extends along a respective longitudinal axis A4 for a variable length and comprises a cylindrical body 27 and a piston 28, which is engaged in a sliding manner in the cylindrical body 27 along the longitudinal axis A4 and delimits together with the cylindrical body 27 a variable volume chamber 29 configured to contain a pressurized fluid.

In certain non-limiting embodiments of the present disclosure, each hydraulic damper 39 comprises an accumulator 31, which is arranged outside the respective hydraulic cylinder 8 and is configured to contain the pressurised fluid; a hydraulic circuit 32, which comprises a connecting duct 40 fluidically connecting the accumulator 31 to the variable volume chamber 29; and a control valve 33, which is in communication with the control device 9 and is configured to adjust a flow of fluid in the hydraulic circuit 32.

In certain embodiments, the control device 9 is configured to control the control valve 33 to adjust the damping coefficient of the respective hydraulic damper 39. In more detail, each control valve 33 is configured to selectively enable/block a passage of a fluid flow in the connecting duct 40.

In certain non-limiting embodiments of the present disclosure, the hydraulic circuit 32 comprises a branch 41 and a branch 42, which is arranged in parallel with the branch 41 and has a narrowing 43. The control valve 33 is of the three-way type and is controllable by the control device 9 so as to selectively assume a first configuration, wherein the control valve 33 fluidically connects the accumulator 31 to the variable volume chamber 29 via the branch 41, and a second configuration, wherein the control valve 33 fluidically connects the accumulator 31 to the variable volume chamber 29 via the branch 42.

In accordance with certain variant embodiments of the present disclosure (not shown in the Figures), instead of the narrowing 43, the branch 42 may have a blockage, which prevents the passage of fluid flow through the branch 42.

In accordance with certain further embodiments (not shown in the Figures), each control valve 33 comprises a plug (not shown in the Figures) movable between an open position, in which the plug enables or allows a passage of fluid flow through the control valve 33, and a closed position, in which the plug blocks a passage of fluid flow through the control valve 33. By way of example, the control valve 33 is a solenoid valve, in particular of the on-off or proportional type.

In certain embodiments, each hydraulic damper 39 comprises a pressure sensor 34, which is in communication with the control device 9 and is configured to detect a pressure signal indicative of the fluid pressure in the hydraulic circuit 32.

In certain non-limiting embodiments of the present disclosure, each hydraulic damper 39 comprises an accumulator 35, which is arranged outside the respective cylindrical body 27 and is configured to contain the pressurised fluid; a hydraulic circuit 36, which comprises a connecting duct 44 fluidically connecting the accumulator 35 to the respective variable volume chamber 29; and a control valve 37, which is in communication with the control device 9 and is configured to adjust a fluid flow in the hydraulic circuit 36. In practice, the connecting ducts 40 and 44 connect the accumulator 31 and accumulator 35, respectively, in parallel with the variable volume chamber 29.

In certain embodiments, the accumulator 31 comprises a first tank having a first capacity and the accumulator 35 comprises a second tank having a second capacity smaller than the first capacity. In more detail, each accumulator 31, 35 is of the type wherein the inner space is divided by a membrane into two compartments, one of which is occupied by air or another gas, while the other compartment is occupied by the substantially incompressible hydraulic fluid. In this way, depending on the degree of filling occupied by the hydraulic fluid, it is possible to provide a certain amount of elastic rigidity to the hydraulic cylinder 8. It is understood that, in accordance with a non-limiting embodiment, the hydraulic circuit 36 and control valve 37 are of the same type as the hydraulic circuit 32 and control valve 33 respectively.

In certain embodiments, the hydraulic circuit 36 comprises a branch 45 and a branch 46, which is arranged parallel to the branch 45 and has a narrowing 47. The control valve 37 is of the three-way type and is controllable by the control device 9 so as to selectively assume a first configuration, wherein the control valve 37 fluidically connects the accumulator 35 to the variable volume chamber 29 via the branch 45, and a second configuration, wherein the control valve 37 fluidically connects the accumulator 35 to the variable volume chamber 29 via the branch 46.

In certain embodiments, each hydraulic damper 39 comprises a pressure sensor 38, which is in communication with the control device 9 and is configured to detect a pressure signal indicative of the fluid pressure in the hydraulic circuit 36.

In accordance with certain variant embodiments of the present disclosure (not shown in the Figures), each hydraulic damper 39 may be of the magnetorheological or electrorheological type. In accordance with these variants, each hydraulic damper 39 comprises a cylinder configured to contain a fluid of an electrorheological or magnetorheological type, a piston engaged in a sliding manner within the cylinder, and an electric/magnetic field generator configured to generate an electric/magnetic field in order to adjust the viscosity of the fluid of an electrorheological or magnetorheological type contained in the cylinder. In certain embodiments, each hydraulic damper 39 manufactured in accordance with the variants is without accumulators, hydraulic connection circuits and control valves.

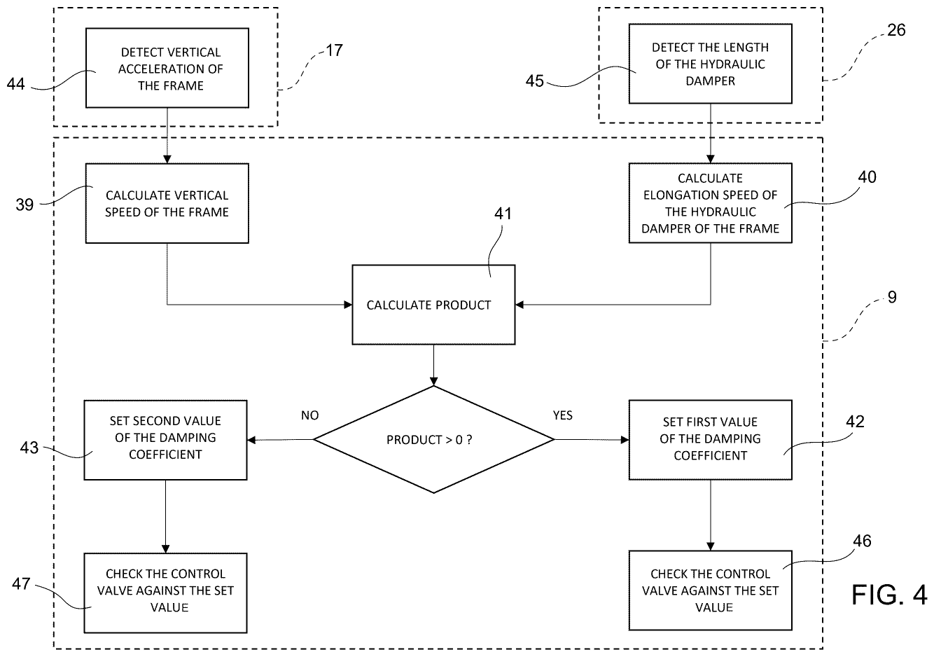

With reference to FIG. 4, the control device 9 is configured to adjust each damping coefficient in real time according to the detected acceleration signal and the respective detected stroke signal.

In certain embodiments, the control device 9 is configured to calculate a speed of the frame 2 in a direction substantially perpendicular to the travelling direction D based on or otherwise as a function of the detected acceleration signal (block 39); calculate an elongation speed of each hydraulic cylinder 8 as a function of the respective detected stroke signal (block 40); calculate a product between the speed of the frame 2 and the elongation speed (block 41); set a first value of the respective damping coefficient in the case where the product is greater than zero (block 42); and set a second value of the respective damping coefficient in the case where the product is less than or equal to zero (block 43), wherein the second value is different from the first value and, in certain instances, the second value is smaller than the first value.

In practice of certain embodiments, the control device 9 is configured to control each control valve 33, 37 as a function of the set damping coefficient value. In more detail, the control device 9 is configured to set the damping coefficient value according to a “Skyhook” control logic. In other words:

$${c}_{s} = \{ \begin{matrix}{c}_{max} , & {\dot{x}}_{s} ( {\dot{x}}_{s} - {\dot{x}}_{u} ) > 0 \\ {c}_{min} , & {\dot{x}}_{s} ( {\dot{x}}_{s} - {\dot{x}}_{u} ) \leq 0\end{matrix}$$

wherein cₛ represents the damping coefficient of each hydraulic damper 39; cₘₐₓ represents the first value of the damping coefficient of each hydraulic damper 39; cₘᵢₙ represents the second value of the damping coefficient of each hydraulic damper 39; \dot{x}ₛ represents the speed of the frame 2 in a substantially vertical direction; and (\dot{x}ₛ-\dot{x}ᵤ) represents the elongation speed of each hydraulic cylinder 8.

In certain embodiments, when each control valve 33, 37 forces the passage of the fluid flow through the respective branch 42, 46, the damping coefficient cₛ assumes the first maximum value cₘₐₓ. When each control valve 33, 37 enables or allows the free passage of fluid flow in the respective hydraulic circuit 32, 36, forcing the passage of the fluid flow through the respective branches 41, 45, the damping coefficient cₛ assumes the second smallest value cₘᵢₙ.

In certain non-limiting embodiments of the present disclosure, the control device 9 implements an on-off-type “Skyhook” control logic.

However, it is understood that, in accordance with variant embodiments of the present disclosure, the control device 9 may implement a further control logic of each valve 33, 37 which enables or allows to adjust the fluid flow in a partializable manner in the respective hydraulic circuit 32, 36. In accordance with this control logic, it is possible to adjust the value of the damping coefficient of each hydraulic damper 39.

In use and with reference to FIG. 4, each acceleration sensor 17 detects an acceleration signal indicative of the acceleration of the frame 2 in a direction substantially perpendicular to the travelling direction D (block 44). At the same time, each stroke sensor 26 detects a respective stroke signal indicative of the length of the respective hydraulic cylinder 8 (block 45).

The control device 9 receives the detected acceleration signals and calculates the vertical speed of the frame 2 as a function of the acceleration signals at the position of the acceleration sensors 17 (block 39). Likewise, the control device 9 receives the detected stroke signals and calculates the extension speed of each hydraulic cylinder 8 as a function of the respective stroke signal (block 40). At this point, the control device 9 calculates the product between each elongation speed and the corresponding speed of the frame 2 (block 41).

In case the product is greater than zero, the control device 9 sets a first value for the damping coefficient of the respective hydraulic damper 39 (block 42). In certain embodiments, in such a circumstance, the control device 9 sends a control signal to each control valve 33, 37 so as to block the passage of fluid flow of in the respective hydraulic circuit 32, 36 (block 46). In this way, the damping coefficient of the respective hydraulic damper 39 assumes a maximum value.

Conversely, if the product is lower than or equal to zero, the control device 9 sets a second value for the damping coefficient of the respective hydraulic damper 39 (block 43). In particular, in such a circumstance, the control device 9 sends a control signal to each control valve 33, 37 so as to enable the passage of fluid flow in the respective hydraulic circuit 32, 36 (block 47). In this way, the damping coefficient of the respective hydraulic damper 39 assumes a minimum value.

It is clear that variants can be made to the present disclosure without, however, departing from the scope of protection of the appended claims. That is, the present disclosure also covers embodiments that are not described in the detailed description above as well as equivalent embodiments that are part of the scope of protection set forth in the claims. Accordingly, various changes and modifications to the presently disclosed embodiments will be apparent to those skilled in the art.

The invention is claimed as follows:

1. A crawler vehicle configured to advance in a travelling direction, the crawler vehicle comprising:
a frame;
two wheel assemblies arranged on opposite sides of the frame, each wheel assembly comprising a drive wheel and a plurality of idle wheels;
two tracks, each track arranged around a respective one of the two wheel assemblies;
a suspension comprising at least two semi-active hydraulic dampers, wherein each semi-active hydraulic damper has a variable damping coefficient, is associated with one of the two wheel assemblies, and comprises a hydraulic cylinder that connects at least one of the idle wheels of the associated wheel assembly to the frame; and
a control device configured to control each semi-active hydraulic damper to adjust the variable damping coefficient of that semi-active hydraulic damper.

2. The crawler vehicle of claim 1, wherein the suspension comprises at least two connecting assemblies, each of which is associated with one of the hydraulic cylinders and connects the associated hydraulic cylinder to two idle wheels of the respective wheel assembly.

3. The crawler vehicle of claim 2, wherein each connecting assembly comprises:
a swivel arm connected to the associated hydraulic cylinder and hinged to the frame; and
a support crossbar hinged to the swivel arm and rotatably supporting the two idle wheels.

4. The crawler vehicle of claim 1, wherein the suspension comprises four hydraulic cylinders, each hydraulic cylinder connecting two respective idle wheels to the frame.

5. The crawler vehicle of claim 1, wherein each hydraulic cylinder extends along a respective longitudinal axis for a variable length and comprises:
a cylindrical body, and
a piston which is slidingly engaged in the cylindrical body along the respective longitudinal axis and delimits, together with the cylindrical body, a variable volume chamber configured to contain a pressurized fluid.

6. The crawler vehicle of claim 5, further comprising:
an acceleration sensor in communication with the control device and configured to detect an acceleration signal indicative of an acceleration of the frame in a direction substantially perpendicular to the travelling direction; and
at least two stroke sensors, wherein each stoke sensor is in communication with the control device, is associated with one of the hydraulic cylinders and is configured to detect a stroke signal indicative of the length of the respective hydraulic cylinder.

7. The crawler vehicle of claim 6, wherein the control device is configured to adjust each damping coefficient based on the detected acceleration signal and the respective detected stroke signal.

8. The crawler vehicle of claim 7, wherein the control device is configured to:
calculate a speed of the frame in the direction substantially perpendicular to the travelling direction based on the detected acceleration signal;
calculate an elongation speed of one of the hydraulic cylinders based on the respective detected stroke signal;
calculate a product between the speed of the frame and the elongation speed;
set a first value of the respective damping coefficient when the product is greater than zero; and
set a second value of the respective damping coefficient when the product is less than or equal to zero, wherein the second value is different from the first value.

9. The crawler vehicle of claim 5, wherein each semi-active hydraulic damper comprises:
an accumulator arranged outside the respective hydraulic cylinder and is configured to contain the pressurized fluid;
a hydraulic circuit fluidically connecting the accumulator to the variable volume chamber; and
a control valve in communication with the control device and configured to adjust a flow of fluid in the hydraulic circuit.

10. The crawler vehicle of claim 9, wherein the control device is configured to control the control valve to adjust the damping coefficient of the respective semi-active hydraulic damper.

11. The crawler vehicle of claim 9, wherein each control valve is configured to selectively enable or block a passage of a fluid flow in the respective hydraulic circuit.

12. A method of operating a crawler vehicle comprising a frame, two wheel assemblies arranged on opposite sides of the frame, each wheel assembly comprising a drive wheel and a plurality of idle wheels, two tracks, each track arranged around a respective one of the two wheel assemblies, a suspension comprising at least two semi-active hydraulic dampers, wherein each semi-active hydraulic damper has a variable damping coefficient, is associated with one of the two wheel assemblies, and comprises a hydraulic cylinder that connects at least one of the idle wheels of the associated wheel assembly to the frame, and a control device configured to control each semi-active hydraulic damper, the method comprising:
detecting an acceleration signal indicative of an acceleration of the frame in a direction substantially perpendicular to a travelling direction of the crawler vehicle;
detecting a stroke signal indicative of a length of one of the hydraulic cylinders; and
adjusting the variable damping coefficient of the semi-active hydraulic damper comprising the hydraulic cylinder based on the detected acceleration signal and the detected stroke signal.

13. The method of claim 12, further comprising:
calculating a speed of the frame in the direction substantially perpendicular to the travelling direction based on the detected acceleration signal;
calculating an elongation speed of one of the hydraulic cylinders based on the respective detected stroke signal;
calculating a product between the speed of the frame and the elongation speed;
setting a first value of the damping coefficient of the semi-active hydraulic damper comprising the hydraulic cylinder when the product is greater than zero; and
setting a second value of the damping coefficient of the semi-active hydraulic damper when the product is less than or equal to zero, wherein the second value is different from the first value.

14. The method of claim 12, further comprising adjusting a flow of a fluid in a hydraulic circuit to adjust the damping coefficient of the respective semi-active hydraulic damper, wherein the hydraulic circuit fluidically connects a variable volume chamber of one of the hydraulic cylinders to an accumulator.

15. A non-transitory computer-readable medium that stores a plurality of instructions that, when executed by a control device of a crawler vehicle comprising a frame, two wheel assemblies arranged on opposite sides of the frame, each wheel assembly comprising a drive wheel and a plurality of idle wheels, two tracks, each track arranged around a respective one of the two wheel assemblies, and a suspension comprising at least two semi-active hydraulic dampers, wherein each semi-active hydraulic damper has a variable damping coefficient, is associated with one of the two wheel assemblies, and comprises a hydraulic cylinder that connects at least one of the idle wheels of the associated wheel assembly to the frame, cause the control device to:
detect an acceleration signal indicative of an acceleration of the frame in a direction substantially perpendicular to a travelling direction of the crawler vehicle;
detect a stroke signal indicative of a length of one of the hydraulic cylinders; and
adjust the variable damping coefficient of the semi-active hydraulic damper comprising the hydraulic cylinder based on the detected acceleration signal and the detected stroke signal.
